(19) United States
(12) Patent Application Publication
(10) Pub. No.: US 2026/0370411 A1
(43) Pub. Date: Nov. 19, 2026

(54) QUASI-COLOCATION DEFINITION AND INDICATION FOR NON-LINEAR MODEL ESTIMATION

(71) Applicant: QUALCOMM Incorporated, San Diego, CA (US)

(72) Inventors: Abdelrahman Mohamed Ahmed Mohamed IBRAHIM, San Diego, CA (US); Igor GUTMAN, Hod HaSharon, Haifa District (IL); Juergen CEZANNE, Ocean Township, NJ (US); Pushkar Bajirao KULKARNI, San Diego, CA (US); Junyi LI, Greentown, PA (US); Joseph Patrick BURKE, Carlsbad, CA (US); Tingfang JI, San Diego, CA (US); Tao LUO, San Diego, CA (US)

(21) Appl. No.: 19/142,721

(22) PCT Filed: Dec. 28, 2023
(86) PCT No.: PCT/US2023/086174

§ 371 Date: Jun. 24, 2025

(30) Foreign Application Priority Data
Jan. 12, 2023 (IL) 299851

(51) Int. Cl. H04L 5/00; H04W 72/231

(52) U.S. Cl. CPC H04L 5/0051; H04W 72/231

(57) ABSTRACT

Aspects relate to estimating and utilizing a non-linear model in wireless communication while considering a quasi-colocation are provided. The network entity may transmit, to a user equipment (UE), a quasi co-location (QCL) indication indicating a QCL type. The network entity may receive, from the UE, a reference signal according to the indicated QCL type, and determine a first non-linear model based on the received reference signal. The network entity may receive, from the UE, uplink communication including uplink data according to the indicated QCL type, and process the received uplink communication based on a second non-linear model that is based on the first non-linear model. Other aspects, embodiments, and features are also claimed and described.

### TECHNICAL FIELD

The present Application for Patent claims priority to pending Israel Non-Provisional Application no. 299851, filed Jan. 12, 2023, and assigned to the assignee hereof and hereby expressly incorporated by reference herein as if fully set forth below and for all applicable purposes.

The technology discussed below relates generally to wireless communication systems, and more particularly, to estimating and utilizing a non-linear model for signals communicated according to a quasi-colocation.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, frequency bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

In wireless communication systems, such as those specified under standards for 5G New Radio (NR), two antenna ports for two respective reference signals may be quasi co-located (QCLed) when properties of the channel over which a symbol on one antenna port is conveyed can be inferred from the channel over which a symbol on the other antenna port is conveyed. Hence, if two reference signals are in a quasi co-location (QCL) relationship, then the symbol from one antenna port for one reference signal may be correlated with the symbol from the other antenna port for the other reference signal. Signal reception for signals in QCL relationship may be improved according to various approaches.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Aspects of the disclosure may include defining and utilizing a type of quasi-colocation for a non-linear model so that a non-linear model estimated based on the reference signal may be used for the uplink communication. As such, non-linear distortions in the uplink communication received at a receiving device may be effectively removed or reduced.

In one example, a method of wireless communication by a network entity is disclosed. The method includes transmitting, to a user equipment (UE), a quasi co-location (QCL) indication indicating a QCL type, receiving, from the UE, a reference signal according to the indicated QCL type, determining a first non-linear model based on the received reference signal, receiving, from the UE, uplink communication including uplink data according to the indicated QCL type, and processing the received uplink communication based on a second non-linear model that is based on the first non-linear model.

In another example, a base station for wireless communication is disclosed. The base station includes at least one processor, a transceiver communicatively coupled to the at least one processor, and a memory communicatively coupled to the at least one processor. The at least one processor may be configured to: transmit, to a user equipment (UE), a quasi co-location (QCL) indication indicating a QCL type, receive, from the UE, a reference signal according to the indicated QCL type, determine a first non-linear model based on the received reference signal, receive, from the UE, uplink communication including uplink data according to the indicated QCL type, and process the received uplink communication based on a second non-linear model that is based on the first non-linear model.

In another example, a non-transitory computer-readable storage medium having instructions for a base station thereon may be disclosed. The instructions, when executed by a processing circuit, cause the processing circuit to: transmit, to a user equipment (UE), a quasi co-location (QCL) indication indicating a QCL type, receive, from the UE, a reference signal according to the indicated QCL type, determine a first non-linear model based on the received reference signal, receive, from the UE, uplink communication including uplink data according to the indicated QCL type, and process the received uplink communication based on a second non-linear model that is based on the first non-linear model.

In a further example, a base station for wireless communication may be disclosed. The base station includes means for transmitting, to a UE, a QCL indication indicating a QCL type, means for receiving, from the UE, a reference signal according to the indicated QCL type, means for determining a first non-linear model based on the received reference signal, means for receiving, from the UE, uplink communication including uplink data according to the indicated QCL type, and means for processing the received uplink communication based on a second non-linear model that is based on the first non-linear model.

In one example, a method of wireless communication by a UE is disclosed. The method includes receiving, from a network entity, a quasi co-location (QCL) indication indicating a QCL type, transmitting, to the network entity, a reference signal according to the indicated QCL type to cause the network entity to determine a first non-linear model based on the reference signal, and transmitting, to the network entity, uplink communication including uplink data according to the indicated QCL type, wherein the uplink communication is received based on a second non-linear model that is based on the first non-linear model.

In another example, a UE for wireless communication is disclosed. The UE includes at least one processor, a transceiver communicatively coupled to the at least one processor, and a memory communicatively coupled to the at least one processor. The at least one processor may be configured to: receive, from a network entity, a quasi co-location (QCL) indication indicating a QCL type, transmit, to the network entity, a reference signal according to the indicated QCL type to cause the network entity to determine a first non-linear model based on the reference signal, and transmit, to the network entity, uplink communication including uplink data according to the indicated QCL type, wherein the uplink communication is received based on a second non-linear model that is based on the first non-linear model.

In another example, a non-transitory computer-readable storage medium having instructions for UE thereon may be disclosed. The instructions, when executed by a processing circuit, cause the processing circuit to: receive, from a network entity, a quasi co-location (QCL) indication indicating a QCL type, transmit, to the network entity, a reference signal according to the indicated QCL type to cause the network entity to determine a first non-linear model based on the reference signal, and transmit, to the network entity, uplink communication including uplink data according to the indicated QCL type, wherein the uplink communication is received based on a second non-linear model that is based on the first non-linear model.

In a further example, a UE for wireless communication may be disclosed. The UE includes means for receiving, from a network entity, a QCL indication indicating a QCL type, means for transmitting, to the network entity, a reference signal according to the indicated QCL type to cause the network entity to determine a first non-linear model based on the reference signal, and means for transmitting, to the network entity, uplink communication including uplink data according to the indicated QCL type, wherein the uplink communication is received based on a second non-linear model that is based on the first non-linear model.

These and other aspects of the disclosure will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a block diagram illustrating a wireless communication system supporting multiple-input multiple-output (MIMO) communication.

FIG. 4 is a schematic illustration of an organization of wireless resources in an air interface utilizing orthogonal frequency divisional multiplexing (OFDM) according to some aspects.

FIG. 5 is an example table showing various maximum power reduction (MPR) values depending for different modulation coding schemes (MCSs), according to some aspects.

FIG. 6 is an example diagram illustrating a non-linearity in uplink (UL) communication, according to some aspects.

FIG. 7A is an example diagram illustrating a reference signal and an error, according to some aspects.

FIG. 7B is an example diagram illustrating the reference signal of FIG. 7A and a measured signal, according to some aspects.

FIG. 8 is an example diagram illustrating features and communications performed by a UE and a network entity, according to some aspects.

FIG. 9 is an example diagram illustrating a signaling diagram of communications between a UE and a network entity, according to some aspects.

FIG. 10 is a block diagram conceptually illustrating an example of a hardware implementation for a network entity according to some aspects.

FIG. 11 is a flow chart illustrating an exemplary process for a network entity according to some aspects.

FIG. 12 is a block diagram conceptually illustrating an example of a hardware implementation for a user equipment according to some aspects.

FIG. 13 is a flow chart illustrating an exemplary process for a user equipment according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

Non-linear distortions may be introduced in a signal transmitted from a transmitting device. For example, when a signal is amplified by a power amplifier for the transmitting device, the power amplifier may introduce non-linear distortions to the signal, and thus the amplified signal may have non-linear distortions. When the amplified signal is transmitted and received by a receiving device, a non-linear model may be used to remove the non-linear distortions in the amplified signal received by a receiver. The non-linear model may be estimated based on a reference signal. When an uplink communication including uplink data is received, the uplink communication may be corrected based on the non-linear model. In order to implement this approach, quasi-colocation for a non-linear model of a channel may be newly defined and utilized so that a non-linear model estimated based on the reference signal may be used for the uplink communication.

According to some aspects of the disclosure, a network entity may indicate a type of quasi-colocation to a UE. As such, the UE may transmit and the network entity may receive a reference signal according to the indicated type of quasi-colocation. Based on the received reference signal, the network entity may estimate a first non-linear model. Thereafter, the UE may transmit, and the network entity may receive a uplink communication including uplink data according to the indicated type of quasi-colocation. Subsequently, the network entity may process the received uplink communication based on a second non-linear model that is based on the first non-linear model. The second non-linear model may be identical to the first non-linear model according to one type of quasi-colocation, or may be related to the first non-linear model according to another type of quasi-colocation.

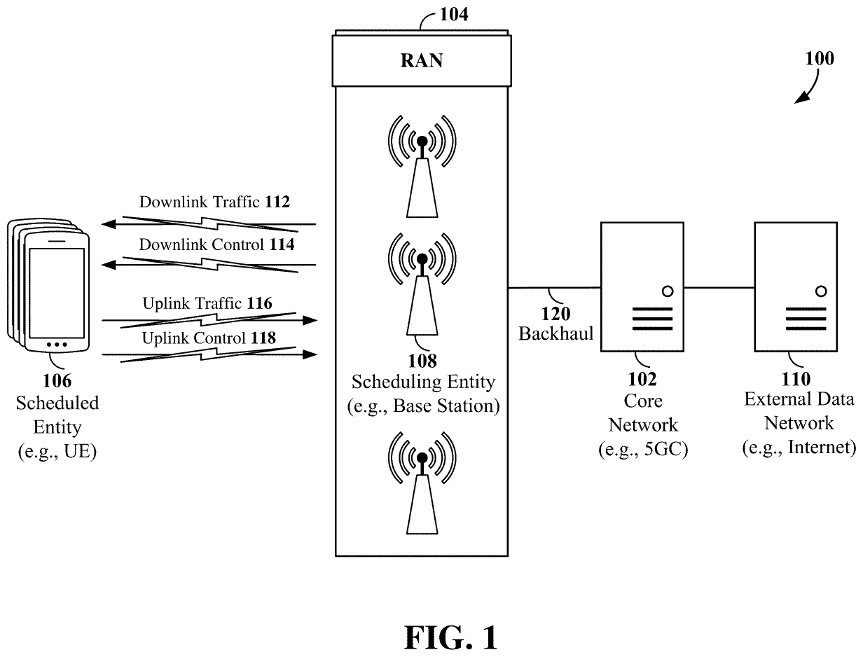

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

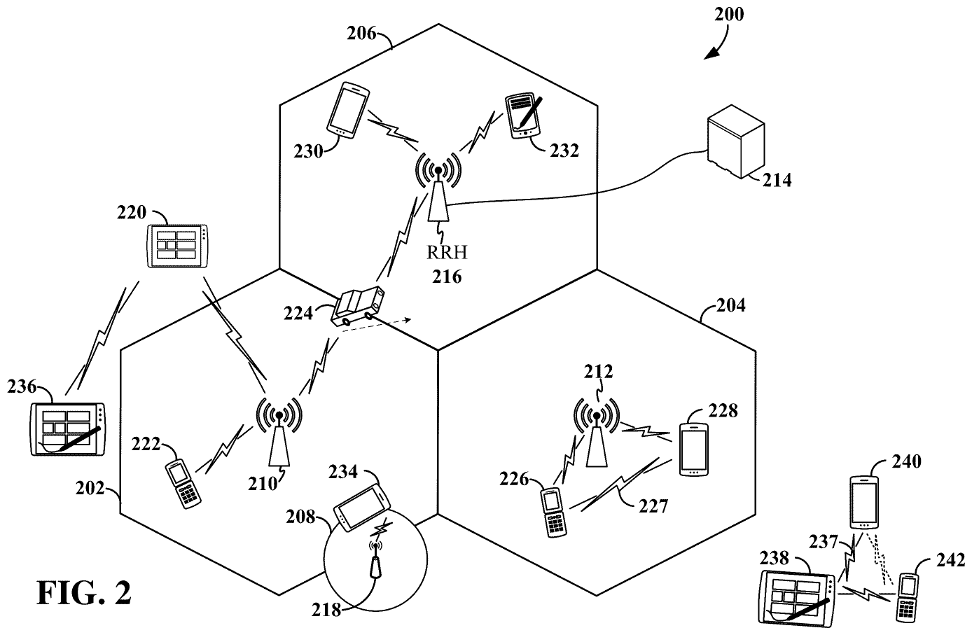

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

In some examples, beamformed signals may be utilized between the UE 228 and the base station 212 communicating, for example, over a mmWave carrier, such as FR2, FR4-a, FR4-1, FR4, or FR5. To facilitate beamformed multi-stream communication, the base station 212 may select a respective beam pair link (BPL) between the UE 228 and the base station 212 for spatial division multiplexing (SDM) of a respective stream on each of the BPLs. Each selected BPL may be associated with a respective transmission configuration indicator (TCI) state that indicates quasi co-location (QCL) information (e.g., QCL-Types) between a downlink reference signal, such as a synchronization signal block (SSB) or channel state information-reference signal (CSI-RS), and a downlink signal or downlink channel (e.g., a physical downlink shared channel) communicated on the selected BPL.

An example of QCL information includes QCL-TypeD, which indicates a spatial property of a beam (e.g., a beam direction and/or beam width) associated with a particular downlink reference signal. By indicating the QCL-TypeD information for a PDSCH transmission, the base station 212 may inform the UE 228 that the PDSCH transmission uses the same downlink (transmit) beam as a configured reference signal. In simple terms, it may be said that a TCI state can include a beam indication that explicitly identifies which downlink beam is being used by the base station 212.

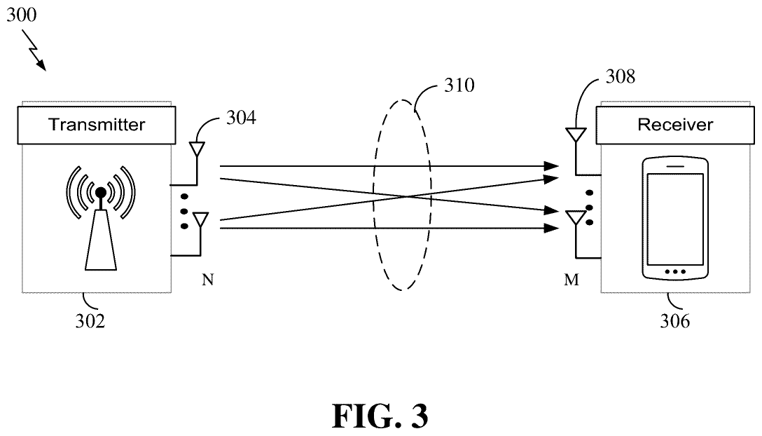

In some aspects of the disclosure, the scheduling entity and/or scheduled entity may be configured for beamforming and/or multiple-input multiple-output (MIMO) technology. FIG. 3 illustrates an example of a wireless communication system 300 supporting MIMO. In a MIMO system, a transmitter 302 includes multiple transmit antennas 304 (e.g., N transmit antennas) and a receiver 306 includes multiple receive antennas 308 (e.g., M receive antennas). Thus, there are N×M signal paths 310 from the transmit antennas 304 to the receive antennas 308. Each of the transmitter 302 and the receiver 306 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 300 is limited by the number of transmit or receive antennas 304 or 308, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C—RS sequences for each layer to provide for multi-layer channel estimation. From the CSI-RS, the UE may measure the channel quality across layers and resource blocks and feed back the CQI and RI values to the base station for use in updating the rank and assigning REs for future downlink transmissions.

In the simplest case, as shown in FIG. 3, a rank-2 spatial multiplexing transmission on a 2×2 MIMO antenna configuration will transmit one data stream from each transmit antenna 304. Each data stream reaches each receive antenna 308 along a different signal path 310. The receiver 306 may then reconstruct the data streams using the received signals from each receive antenna 308.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

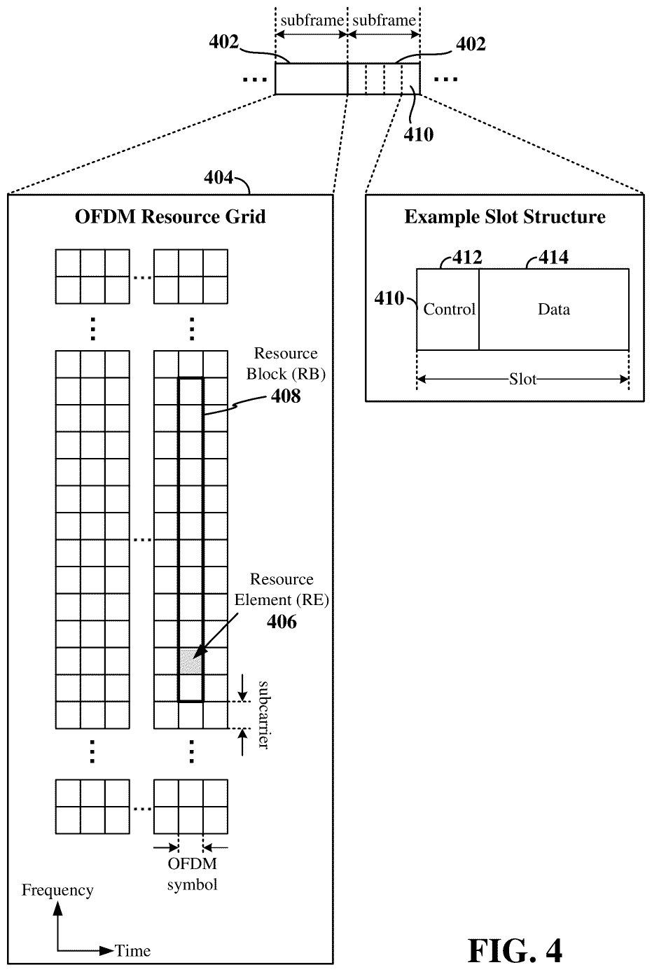

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 4, an expanded view of an exemplary subframe 402 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 404 may be used to schematically represent time-frequency resources for a given antenna port. That is, in a multiple-input-multiple-output (MIMO) implementation with multiple antenna ports available, a corresponding multiple number of resource grids 404 may be available for communication. The resource grid 404 is divided into multiple resource elements (REs) 406. An RE, which is 1 subcarrier× 1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each 1 ms subframe 402 may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels, and the data region 414 may carry data channels. Of course, a slot may contain all DL, all UL, or at least one DL portion and at least one UL portion. The structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 412 of the slot 410 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 414 of the slot 410 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 406 within slot 410. For example, HARQ feedback information may be transmitted in a physical sidelink feedback channel (PSFCH) within the slot 410 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 410.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

High MCS use cases and QPSK UL use cases may realize gains using nonlinear (NL) UL compressed OFDM waveforms. High MCS UL operations may significantly suffer in range due to a backed off (e.g., lower) UE transmit (Tx) pout and (larger) required gNB receive (Rx) signal-to-noise ratios (SNRs). A new UE Tx crest factor reduction (CFR), linearization and bias methods combined with smart gNB NL Rx designs may provide improved performance.

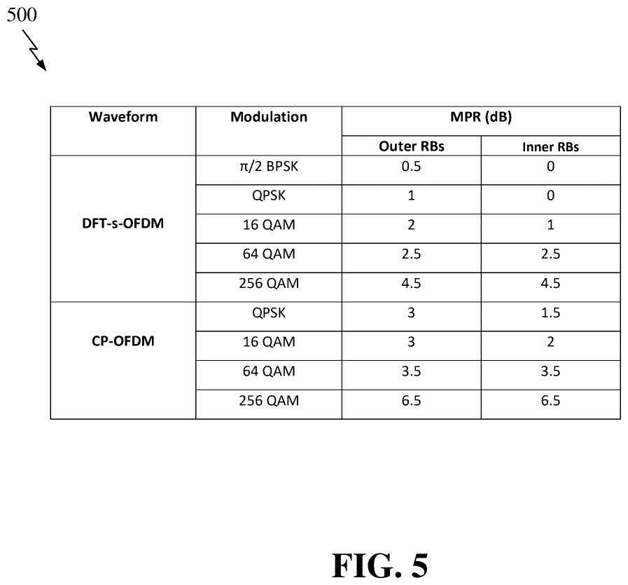

For example, a maximum power (e.g., 26 dB) may differ depending on the capability of a UE. The requirements for different MCS and different allocations may be different. Hence, a maximum power reduction (MPR) may be predefined. An MPR may indicate to a UE that the UE can back off the power only up to a particular maximum amount if the UE meets certain transmission requirements. FIG. 5 is an example table 500 showing various MPR values depending for different MCSs, according to some aspects. As shown in FIG. 5, the MPR value is generally higher for a higher MCS.

Tx requirements may be in an error vector magnitude (EVM), which is associated with a quality of signal. Further, requirements may also include an out-of-band requirement. For an UL signal, because of the imperfect nature of a power amplifier (PA), there are spectrums that are out of band. Backing off the power may meet the out-of-band (side bands) requirements and meet the EVM requirements related to a quality of signal in in-band. By increasing the power, the quality of the signal of in-band signal may degrade at a transmitting device. However, a receiving device may be able to compensate for degradation of the quality of the signal. For example, a signal x goes through a PA at a transmitter side, the PA may produce a signal with an NL function f (x), and the receiver side may attempt to remove this NL function.

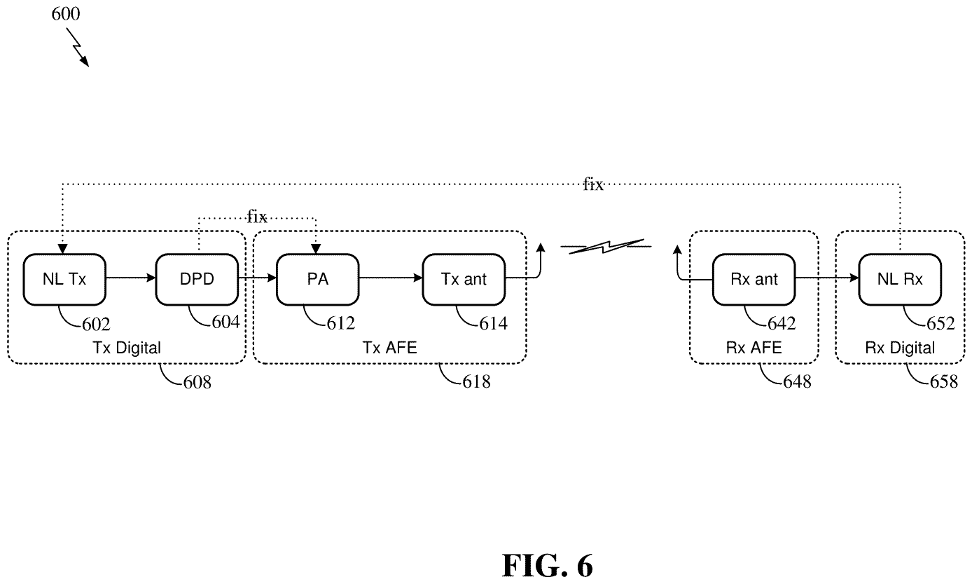

FIG. 6 is an example diagram 600 illustrating a non-linearity in UL communication, according to some aspects. A NL transmitter 602 may reduce a Peak to Average Power Ratio (PAPR) of a signal (e.g., with cost of an EVM), while maintaining the out-of-band emissions requirements. When the PAPR is lower, a higher power may be used to transmit the transmit signal. The transmit signal goes through a digital pre-distortion (DPD) component 604 to somewhat correct the NL portion of the transmit signal prior to power amplification. After going through some correction via the DPD component 604, the transmit signal is amplified via a PA 612, and the amplified transmit signal is transmitted via a transmit antenna 614. In some aspects, the NL transmitter and the DPD component 604 may be a Tx digital portion 608 performing in the digital domain, and thus, for example, may be a part of a base band chip or may be located in a digital front end (DFE). The PA 612 and the transmit antenna 614 may be considered as a Tx analog front-end (AFE) 618. The transmit signal transmitted from the transmit antenna 614 may be received by a receive antenna 642, which may be considered as a Rx AFE 648. The received signal at the receive antenna 642 is forwarded to an NL receiver 652.

When reducing the PAPR of the signal to transmit with a higher power, a PA efficiency may be improved (e.g., with respect to power consumption, link budget, heat dissipation, etc.) However, with the reduced PAPR of the signal, the quality of the transmit signal in in-band (e.g., based on the EVM) may degrade. The correction by the DPD component 604 does not sufficiently correct this degradation of the transmit signal. Hence, the NL receiver 652 may be used to remove the nonlinearity in the transmit signal in the NL transmitter 602 and improve the EVM of the in-band signal. In some aspects, the NL receiver 652 may be an Rx digital portion 658 performing in the digital domain, and thus, for example, may be a part of a base band chip or may be located in a digital front end (DFE).

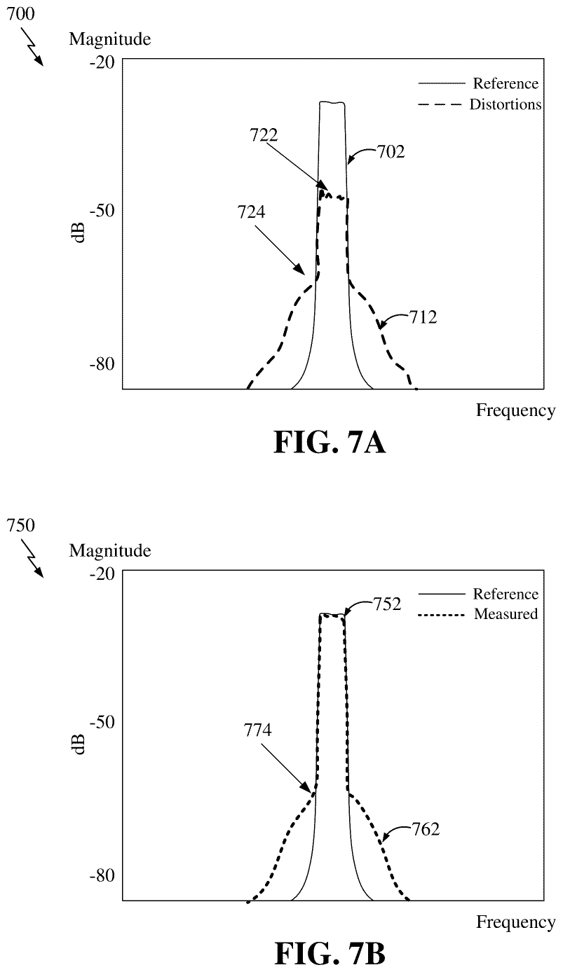

FIG. 7A is an example diagram 700 illustrating a reference signal and distortions, according to some aspects. As shown in FIG. 7A, a reference signal 702 shown in a solid line is a signal without distortions. When the reference signal 702 is passed through a PA, distortions 712 shown in a dashed line may be introduced to the reference signal 702. The distortions 712 may have an SNR limit 722 due to a NL transmitter and an SNR limit 724 due to the PA.

FIG. 7B is an example diagram 750 illustrating the reference signal of FIG. 7A and a measured signal, according to some aspects. In FIG. 7B, the reference signal 752 is in a solid line and is the same as the reference signal 702 of FIG. 7A. The measured signal 762 in FIG. 7B may be a resulting signal when the distortions 712 of FIG. 7A is introduced to the reference signal 702 (or the reference signal 752). The measured signal 762 may be the transmitted signal after being amplified through the PA. The measured signal 762 may have an SNR limit 774 due to the PA. As shown in FIG. 7B, due to the distortions 712, the measured signal 762 has side lobes that the reference signal 752 does not have.

As discussed above, QCL defines a relationship between two reference signals. QCL properties (e.g., for a linear channel) generally include one or more of a delay spread (e.g., signal's delay), a Doppler spread (e.g., delay spread), a Doppler shift (e.g., due to the movement of devices), an average delay, and spatial Rx parameters (e.g., related to Rx beams). If two reference signals are QCLed, if one or more of these properties are measured based on one reference signal, the same properties may be expected for the other reference signal. For example, if two reference signals are QCLed, one reference signal is used to estimate the delay spread, it is assumed that the other reference signal will have the same delay spread. A TCI may be used to configure QCL by an RRC message or DCI.

Some examples of QCL relationships may include the following. In an example, PDSCH DMRS ports in a PDSCH DMRS group may be QCLed. For example, for two QCLed ports, if a delay spread is observed in one port, the same delay spread should be observed in another port. In an example, a PTRS port and a PDSCH DMRS port may be QCLed. In an example, CSI-RS ports within a CSI-RS resource may be QCLed.

There are various types of QCL, and each type of QCL may be associated with a different set of properties. For example, the QCL information included in the TCI may indicate a type of QCL. QCL-type A is associated with a Doppler shift, a Doppler spread, an average delay (e.g., delay offset), and a delay spread. QCL-type B is associated with Doppler properties including a Doppler shift and a Doppler spread. QCL-type C is associated with an average delay and a Doppler shift, and thus is associated with shifts in time and frequency. QCL-type D is associated with spatial RX parameters.

A few approaches are available to estimate an NL model that can be used to remove NL distortions in a receiver when the receiver corrects for the NL portion of the signal. According to a first approach, a DMRS in PUSCH may be used to estimate an NL model. As DMRS symbols may be used to estimate a channel, the DMRS can also be used to estimate nonlinearity. According to a second approach, an NL model estimated from one reference signal may be used to cancel an NL distortion for a PUSCH reception. For example, assuming that a first signal is transmitted and there's an NL response associated with the first signal, and that a receiver estimates the NL response, when a second signal is transmitted with an NL response, the receiver can use the same NL function to cancel non-linearity.

Various aspects of the disclosure are related to the second approach, where a NL model derived based on one UL reference signal may be used to derive an NL model for NL cancellation in reception of a PUSCH. For example, let's assume that an SRS is transmitted on a certain slot and this is used to estimate a NL function. Then, when a PUSCH is transmitted on another slot, then a network entity may estimate the NL function based on the SRS to correct for non-linearity.

In order to implement the second approach, an NL state of a transmitter needs to be the same for a UL reference signal and a corresponding PUSCH transmission. The channel properties for QCL were previously defined for a linear channel, but not for a non-linear channel. The channel properties for QCL may be extended to consider a non-linear state/response, and implement the second approach. Hence, according to various aspects of the disclosure, QCL for NL state of the channel may be newly defined so that an NL state estimated based on a UL reference signal can be used for another UL transmission.

In particular, according to some aspects of the disclosure, a network entity (e.g., base station) may indicate a QCL type to a UE, such that the UE may transmit and the network entity may receive a reference signal, such as an SRS, according to the indicated QCL type. Based on the received reference signal, the network entity may estimate a first NL model. Thereafter, when the network entity receives a UL communication (e.g., PUSCH communication) including uplink data according to the indicated QCL type, the network entity may process the received UL communication based on a second NL model, where the second NL model is based on the first NL model.

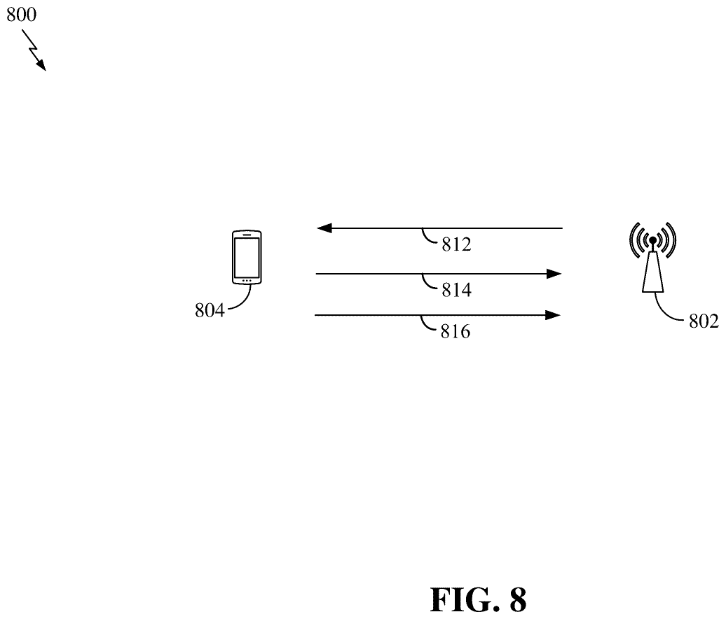

FIG. 8 is an example diagram illustrating features and communications performed by a UE and a network entity, according to some aspects. At 812, a network entity 802 may transmit, and a UE 804 may receive, a QCL indication indicating a QCL type. Then, the UE 804 is configured to transmit according to the indicated QCL type. Hence, a QCL relationship between signals may be newly defined to ensure that ports of two reference signals experience the same NL response. Such a QCL relationship is beneficial because, if we use one signal to estimate NL, then the same NL can be used for the other signal. The NL response may depend on a PA response, transmit power, a PAPR of a signal, a CFR method, etc.

At 814, the UE 804 may transmit, and the network entity 802 may receive, a reference signal according to the indicated QCL type. Subsequently, the network entity 802 may determine a first NL model based on the received reference signal. At 816, the UE 804 may transmit, and the network entity 802 may receive, UL communication including uplink data according to the indicated QCL type. The network entity 802 may then process the received UL communication based on a second NL model that is based on the first NL model.

To estimate an NL model, a set of NL kernels and coefficients for the NL kernels may be selected. In some aspects, the set of NL kernels may be at least one of Volterra kernels, generalized memory polynomial (GMP) kernels, or dynamical dimension reduction (DDR) kernels.

In some aspects, the coefficients for the NL kernels may be expressed based on the following equation.

$$z ( n ) = {\sum }_{m = 0}^{M - 1} \overline{{K}_{x}} ( n - m ) \cdot {\overline{w}}_{m} ,$$

$$Where$$

$${\overline{w}}_{m} = [ {w}_{m , 1} , {w}_{m , 3} , {w}_{m , 51} , {w}_{m , 71} , … {w}_{m , K 1} ]$$

$${\overline{{K}_{x}}}_{( n )} = [ x ( n ) x ( n ) \vert x ( n ) {\vert}^{2} x ( n ) \vert x ( n ) {\vert}^{4} … x ( n ) {\vert x ( n ) \vert}^{K - 1} ]$$

Here, x is the input signal into a PA, [symbol] is an output signal out of the PA, and w is a weight value, and K is the NL kernel. x is a linear portion and the other parameters in this equation represent an NL portion. As shown in the above equation, the NL model may be determined based on a set of kernels [symbol] that are based on a received signal z(n) and a set of weight values w̅ₘ, where each of the weight values w̅ₘ corresponds to a respective one of the kernels [symbol] .

Hence, in an aspect, the first NL model that is based on the received reference signal may be based on a set of first kernels that are based on the received reference signal and a set of first weight values, where each of the first weight values corresponds to a respective one of the first kernels. In this aspect, the second NL model for processing the received UL communication may be based on a set of second kernels that are based on the received reference signal and a set of second weight values, where each of the second weight values corresponds to a respective one of the second kernels. In this aspect, the first NL model may be based on a summation of the set of kernels that are respectively adjusted based on the set of weight values.

In some aspects, according to a first option, a single QCL relationship (e.g., indicated by a QCL type) may determine the NL kernels and the coefficients (e.g., based on the weight values), and thus the single QCL relationship may completely characterize the exact NL model. This QCL relationship type may be referred to as a QCL-typeE, where ports from two UL signals may experience an identical NL response. In this option, an NL model may be derived based on a set of kernels and corresponding weight values. For example, a first UL signal and a second UL signal are QCLed with type-E if the first UL signal and the second UL signal experience the same NL response, which may indicate that the first UL signal and the second UL signal have same PAPR and the same power. Hence, according to the first option, the second NL model for processing the received UL communication may be identical to the first NL model that is based on the received reference signal, according to the indicated QCL type.

In some aspects, according to a second option, two different QCL relationships based on two different QCL types may be available for an NL response. In particular, the two available QCL types may be the QCL-typeE discussed above, and QCL-typeF. In the QCL-typeF, two UL signals may not experience the exact NL response, but may share some NL properties. Thus, the QCL-typeF may indicate a weaker form of linkage between two NL responses experienced by two UL signals. Hence, in an aspect, according to the second option, if the QCL-typeF is indicated as the indicated QCL type, the second NL model for processing the received UL communication may be based on the first NL model that is based on the received reference signal and may be different from the first NL model.

In a first aspect with the QCL-typeF indicated, two NL models corresponding to two UL signals may be represented by the same set of kernels (e.g., K), but the weight values for one NL model may be different from the weight values (e.g., w) for the other NL model. Hence, in an aspect, the set of first kernels in the first NL model that is based on the received reference signal may be the same as the set of second kernels in the second NL model for processing the received UL communication, while the set of first weight values in the first NL model may be different from the set of second weight values in the second NL model.

In a second aspect with the QCL-typeF indicated, two NL models may be decoupled into a common part and two dedicated parts. For example, two NL models may share the same memoryless NL response as the common part and may have two different responses for NL terms with memory as the two dedicated parts. For example, the common portion is based on the m value in the above equation being equal to 0, while the two dedicated parts are based on the m value(s) greater than 0. For example, a memoryless portion may be a portion with the m value equal to 0. Hence, in an aspect, the first NL model that is based on the received reference signal may include a common portion and a first dedicated portion, and the second non-linear model for processing the received UL communication may include the common portion and a second dedicated portion different from the first dedicated portion, where the common portion is based on at least one of the set of first kernels and at least one of the set of first weight values for the first NL model. For example, the common portion may be based on a memoryless kernel (e.g., having the m value equal to 0) of the set of first kernels and a corresponding weight value of the set of first weight values that corresponds to the memoryless portion. For example, the first dedicated portion may be based on kernels with memory (e.g., having the m value greater than 0) of the set of first kernels and corresponding weight values of the set of first weight values, and the second dedicated portion may be based on kernels with memory (e.g., having the m value greater than 0) of the set of second kernels and corresponding weight values of the set of second weight values.

In an aspect, a port for the reference signal may be QCLed with a DMRS port for the UL communication, where, according to the indicated QCL type, the second non-linear model is identical to the first non-linear model. For example, a port for the reference signal (e.g., SRS) may be QCLed according to the QCL-typeE with a DMRS port for the UL communication (e.g., PUSCH communication). This implies that the first NL model estimated based on the received reference signal (e.g., SRS) may be used for processing the received UL communication (e.g., PUSCH). In some aspects, to achieve the port for the reference signal being QCLed with a DMRS port for the UL communication based on the QCL-typeE, the reference signal may follow a power control of the UL communication that is linked to the reference signal. As such, for example, if the power for a PUSCH is increased, the power for an SRS linked to the PUSCH is increased. Having the same power control to ensure they have the same power.

In an aspect, a port for the reference signal may be QCLed with each of two DMRS ports for the UL communication according to the indicated QCL type, and the two DMRS ports may be QCLed with each other according to the second NL model for processing the UL communication. In this aspect, according to the indicated QCL type, the second NL model for processing the UL communication may not identical to the first NL model that is based on the reference signal. For example, a port for a reference signal (e.g., SRS) can be QCLed according to the QCL-typeF with each DMRS port for a UL communication (e.g., PUSCH communication), while two DMRS ports for the UL communication may be QCLed with each other according to the QCL-typeE. According to one approach, any two DMRS ports for a UL communication (e.g., PUSCH communication) may be QCLed according to QCL-typeE, e.g., as long as these two DMRS ports experience the same NL response. According to another approach, two DMRS ports for a UL communication (e.g., PUSCH communication) may be QCLed (e.g., according to QCL-typeE) when one or more of conditions are satisfied. The conditions may include one or more of the two DMRS ports for UL communication (e.g., PUSCH communication) being utilized for two consecutive repetitions of the UL communication, the two DMRS ports being utilized for two consecutive slots for a transport block over multiple slots (TBoMS) transmission, and the two DMRS ports being utilized in a transmission of the UL communication.

In an aspect, the network entity may transmit the QCL indication indicating the QCL type by transmitting a first RRC configuration message for the reference signal and/or a second RRC configuration message for the uplink communication, where the first RRC configuration message and/or the second RRC configuration message includes the QCL indication. Hence, in this aspect, for example, a QCL type for an NL response may be semi-statically configured as a part of an SRS RRC configuration parameter and/or a PUSCH RRC configuration parameter. In an example, an RRC configuration for UL communication (e.g., PUSCH communication) may include an information element to link a reference signal resource (e.g., SRS resource) for estimation of an NL model. In this example, configuration of a certain PUSCH communication is linked to a configuration of a certain SRS transmission, and this linkage may indicate that the SRS resource for the SRS transmission may be used for this PUSCH communication to estimate an NL model.

In an aspect, the network entity may transmit the QCL indication indicating the QCL type by transmitting DCI including the QCL indication and/or by transmitting a MAC-CE including the QCL indication. Hence, in this aspect, a QCL type for an NL response may be dynamically indicated or updated. In an example, the DCI may indicate which SRS is used for NL model estimation. In this example, when a PUSCH is scheduled via the DCI, the DCI may indicate which SRS is used for the NL model estimation. In another example, a list of SRSs may be defined in an RRC message and a MAC-CE may be used to indicate a corresponding PUSCH for each SRS.

In an aspect, the network entity may transmit an RRC configuration message for the UL communication (e.g., PUSCH communication), where the RRC configuration message includes a configured grant (CG) for transmission of the UL communication and a listing various QCL types. In this aspect, the RRC configuration message may indicate a default QCL type out of the various QCL types, and the QCL indication may indicate one of these QCL types. In some aspects, the QCL indication may indicate the default QCL type. Further, in some aspects, a MAC-CE may be used to update the QCL type. The network entity may transmit a MAC-CE including a second QCL indication indicating a second QCL type from the various QCL types, where the second QCL type is different from the default QCL type, such that a second UL communication (e.g., PUSCH) may be received according to the second QCL. The CG in this aspect may be referred to as CG-PUSCH type 1, which does not utilize activation by DCI. In an example, a MAC-CE may be used to switch to a different SRS in the list of SRSs defined in the RRC message discussed above, and thus may indicate a different QCL type that corresponds to the different SRS.

In an aspect, the network entity may transmit the QCL indication by transmitting an RRC configuration message for the UL communication (e.g., PUSCH communication), where the RRC configuration message includes the QCL indication. In this aspect, the network entity may transmit DCI including a CG for transmission of the UL communication. This CG may be referred to as CG-PUSCH type 2, which is activated by DCI. In an example, the DCI may be an activation DC that may indicate an SRS (e.g., from the list of SRSs) associated with a particular QCL type, thereby indicating the particular QCL type.

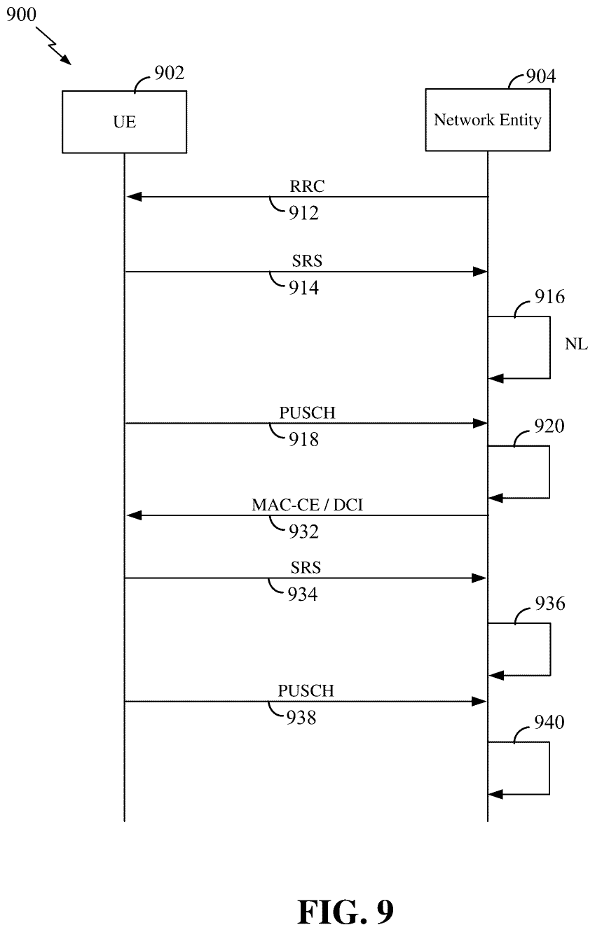

FIG. 9 is an example diagram 900 illustrating a signaling diagram of communications between a UE and a network entity, according to some aspects. At 912, a network entity 904 may transmit an RRC configuration message to a UE 902, where the RRC configuration message includes a first QCL indication indicating a first QCL type. At 914, the UE 902 may transmit, and the network entity 904 may receive, an SRS according to the indicated first QCL type. At 916, the network entity 904 may determine a first NL model based on the received SRS. At 918, the UE 902 transmits, and the network entity 904 receives, a PUSCH according to the indicated first QCL type. At 920, the network entity 904 may process the received PUSCH based on a second NL model, where the second NL model is based on the first NL model. In some aspects, the second NL model may be identical to the first NL model. In other aspects, the second NL model may be different from the first NL model.

As discussed above, the QCL type indicated by the QCL indication may be changed to another QCL type using a MAC-CE or DCI. At 932, the network entity transmit a MAC-CE and/or DCI that indicates a second QCL type different from the first QCL type. At 934, the UE 902 may transmit, and the network entity 904 may receive, an SRS according to the indicated second QCL type. At 936, the network entity 904 may determine a third NL model based on the received SRS. At 938, the UE 902 transmits, and the network entity 904 receives, a PUSCH according to the indicated second QCL type. At 940, the network entity 904 may process the received PUSCH based on a fourth NL model, where the fourth NL model is based on the third NL model. In some aspects, the fourth NL model may be identical to the third NL model. In other aspects, the fourth NL model may be different from the third NL model.

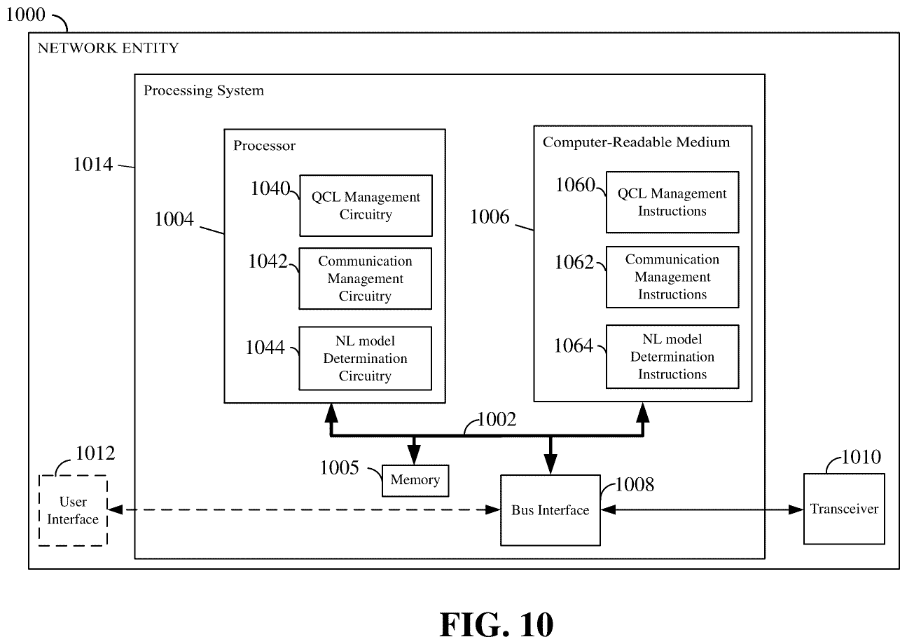

FIG. 10 is a block diagram illustrating an example of a hardware implementation for a network entity 1000 employing a processing system 1014. For example, the network entity 1000 may be a scheduling entity or a base station as illustrated in any one or more of FIGS. 1, 2, 3, 8, and/or 9.

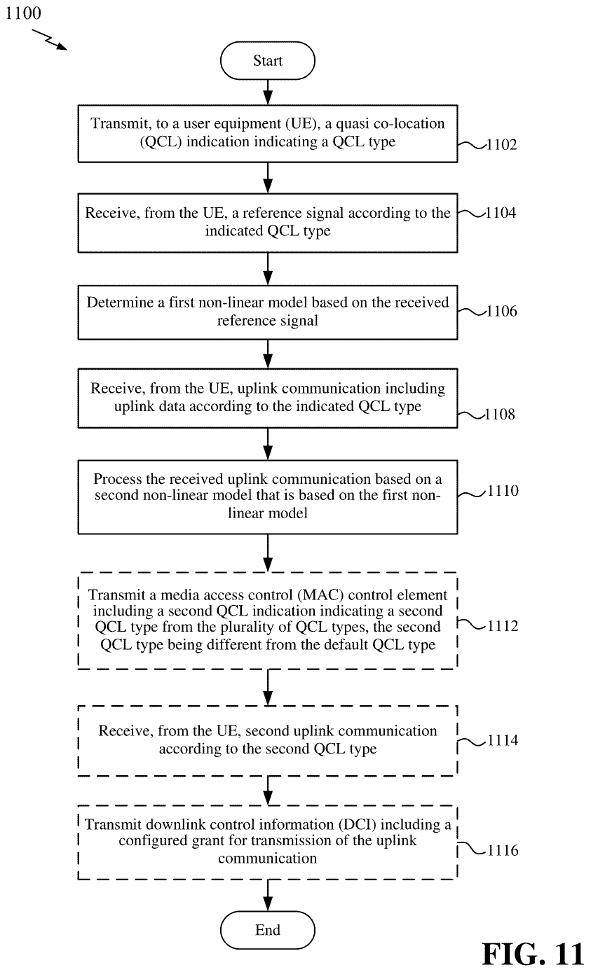

The network entity 1000 may be implemented with a processing system 1014 that includes one or more processors 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network entity 1000 may be configured to perform any one or more of the functions described herein. That is, the processor 1004, as utilized in a network entity 1000, may be used to implement any one or more of the processes and procedures described below and illustrated in FIG. 11.

In this example, the processing system 1014 may be implemented with a bus architecture, represented generally by the bus 1002. The bus 1002 may include any number of interconnecting buses and bridges depending on the specific application of the processing system 1014 and the overall design constraints. The bus 1002 communicatively couples together various circuits including one or more processors (represented generally by the processor 1004), a memory 1005, and computer-readable media (represented generally by the computer-readable storage medium 1006). The bus 1002 may also link various other circuits such as timing sources, peripherals, voltage regulators, and power management circuits, which are well known in the art, and therefore, will not be described any further. A bus interface 1008 provides an interface between the bus 1002 and a transceiver 1010. The transceiver 1010 provides a communication interface or means for communicating with various other apparatus over a transmission medium. Depending upon the nature of the apparatus, a user interface 1012 (e.g., keypad, display, speaker, microphone, joystick) may also be provided. Of course, such a user interface 1012 is optional, and may be omitted in some examples, such as a base station.

In some aspects of the disclosure, the processor 1004 may include QCL management circuitry 1040 configured for various functions, including, for example, transmitting, to a user equipment (UE), a quasi co-location (QCL) indication indicating a QCL type. For example, the QCL management circuitry 1040 may be configured to implement one or more of the functions described below in relation to FIG. 11, including, e.g., block 1102.

In some aspects of the disclosure, the processor 1004 may include communication management circuitry 1042 configured for various functions, including, for example, receiving, from the UE, a reference signal according to the indicated QCL type. For example, the communication management circuitry 1042 may be configured to implement one or more of the functions described below in relation to FIG. 11, including, e.g., block 1104.

In some aspects, the communication management circuitry 1042 may be configured for various functions, including, for example, receiving, from the UE, uplink communication including uplink data according to the indicated QCL type. For example, the communication management circuitry 1042 may be configured to implement one or more of the functions described below in relation to FIG. 11, including, e.g., block 1108.

In some aspects, the communication management circuitry 1042 may be configured for various functions, including, for example, processing the received uplink communication based on a second non-linear model that is based on the first non-linear model. For example, the communication management circuitry 1042 may be configured to implement one or more of the functions described below in relation to FIG. 11, including, e.g., block 1110.

In some aspects, the communication management circuitry 1042 may be configured for various functions, including, for example, transmitting a MAC-CE including a second QCL indication indicating a second QCL type from the plurality of QCL types, the second QCL type being different from the default QCL type. For example, the communication management circuitry 1042 may be configured to implement one or more of the functions described below in relation to FIG. 11, including, e.g., block 1112.

In some aspects, the communication management circuitry 1042 may be configured for various functions, including, for example, receiving, from the UE, second uplink communication according to the second QCL type. For example, the communication management circuitry 1042 may be configured to implement one or more of the functions described below in relation to FIG. 11, including, e.g., block 1114.

In some aspects, the communication management circuitry 1042 may be configured for various functions, including, for example, transmitting DCI including a configured grant for transmission of the uplink communication. For example, the communication management circuitry 1042 may be configured to implement one or more of the functions described below in relation to FIG. 11, including, e.g., block 1116.

In some aspects of the disclosure, the processor 1004 may include NL model determination circuitry 1044 configured for various functions, including, for example, determining a first non-linear model based on the received reference signal. For example, the NL model determination circuitry 1044 may be configured to implement one or more of the functions described below in relation to FIG. 11, including, e.g., block 1106.

The processor 1004 is responsible for managing the bus 1002 and general processing, including the execution of software stored on the computer-readable storage medium 1006. The software, when executed by the processor 1004, causes the processing system 1014 to perform the various functions described below for any particular apparatus. The computer-readable storage medium 1006 and the memory 1005 may also be used for storing data that is manipulated by the processor 1004 when executing software.

One or more processors 1004 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium 1006. The computer-readable storage medium 1006 may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium 1006 may reside in the processing system 1014, external to the processing system 1014, or distributed across multiple entities including the processing system 1014. The computer-readable storage medium 1006 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

In some aspects of the disclosure, the computer-readable storage medium 1006 may include QCL management software/instructions 1060 configured for various functions, including, for example, transmitting, to a user equipment (UE), a quasi co-location (QCL) indication indicating a QCL type. For example, the QCL management software/instructions 1060 may be configured to implement one or more of the functions described below in relation to FIG. 11, including, e.g., block 1102.

In some aspects of the disclosure, the computer-readable storage medium 1006 may include communication management software/instructions 1062 configured for various functions, including, for example, receiving, from the UE, a reference signal according to the indicated QCL type. For example, the communication management software/instructions 1062 may be configured to implement one or more of the functions described below in relation to FIG. 11, including, e.g., block 1104.

In some aspects, the communication management software/instructions 1062 may be configured for various functions, including, for example, receiving, from the UE, uplink communication including uplink data according to the indicated QCL type. For example, the communication management software/instructions 1062 may be configured to implement one or more of the functions described below in relation to FIG. 11, including, e.g., block 1108.

In some aspects, the communication management software/instructions 1062 may be configured for various functions, including, for example, processing the received uplink communication based on a second non-linear model that is based on the first non-linear model. For example, the communication management software/instructions 1062 may be configured to implement one or more of the functions described below in relation to FIG. 11, including, e.g., block 1110.

In some aspects, the communication management software/instructions 1062 may be configured for various functions, including, for example, transmitting a MAC-CE including a second QCL indication indicating a second QCL type from the plurality of QCL types, the second QCL type being different from the default QCL type. For example, the communication management software/instructions 1062 may be configured to implement one or more of the functions described below in relation to FIG. 11, including, e.g., block 1112.

In some aspects, the communication management software/instructions 1062 may be configured for various functions, including, for example, receiving, from the UE, second uplink communication according to the second QCL type. For example, the communication management software/instructions 1062 may be configured to implement one or more of the functions described below in relation to FIG. 11, including, e.g., block 1114.

In some aspects, the communication management software/instructions 1062 may be configured for various functions, including, for example, transmitting DCI including a configured grant for transmission of the uplink communication. For example, the communication management software/instructions 1062 may be configured to implement one or more of the functions described below in relation to FIG. 11, including, e.g., block 1116.

In some aspects of the disclosure, the computer-readable storage medium 1006 may include NL model determination software/instructions 1064 configured for various functions, including, for example, determining a first non-linear model based on the received reference signal. For example, the NL model determination software/instructions 1064 may be configured to implement one or more of the functions described below in relation to FIG. 11, including, e.g., block 1106.

FIG. 11 is a flow chart illustrating an exemplary process 1100 for a network entity in accordance with some aspects. As described below, some or all illustrated features may be omitted in a particular implementation within the scope of the present disclosure, and some illustrated features may not be required for implementation of all embodiments. In some examples, the process 1100 may be carried out by the network entity 1000 illustrated in FIG. 10. In some examples, the process 1100 may be carried out by any suitable apparatus or means for carrying out the functions or algorithm described below.

At block 1102, the network entity may transmit, to a UE, a QCL indication indicating a QCL type. For example, the QCL management circuitry 1040 shown and described above in connection with FIG. 10 may provide means for transmitting the QCL indication.

In some aspects, the transmitting, at block 1102, by the UE, the QCL indication indicating the QCL type may include transmitting at least one of a first RRC configuration message for the reference signal or a second RRC configuration message for the uplink communication, the at least one of the first RRC configuration message or the second RRC configuration message including the QCL indication.

In some aspects, the transmitting, at block 1102, by the UE, the QCL indication indicating the QCL type may include at least one of: transmitting DCI including the QCL indication, or transmitting a MAC-CE including the QCL indication.

In some aspects, the transmitting, at block 1102, by the UE, the QCL indication indicating the QCL type may include transmitting a radio resource control (RRC) configuration message for the uplink communication, the RRC configuration message including a configured grant for transmission of the uplink communication and a listing a plurality of QCL types, the RRC configuration message indicating a default QCL type from the plurality of QCL types, the QCL indication being one of the plurality of QCL types.

At block 1104, the network entity may receive, from the UE, a reference signal according to the indicated QCL type. For example, the communication management circuitry 1042 shown and described above in connection with FIG. 10 may provide means for receiving the reference signal. In an aspect, the reference signal may be an SRS.

At block 1106, the network entity may determine a first non-linear model based on the received reference signal. For example, the NL model determination circuitry 1044 shown and described above in connection with FIG. 10 may provide means for determining the first non-linear model.

In some aspects, the first non-linear model may be based on a plurality of first kernels that are based on the received reference signal and a plurality of first weight values, each of the plurality of first weight values corresponding to a respective one of the plurality of first kernels, and the second non-linear model may be based on a plurality of second kernels that are based on the received reference signal and a plurality of second weight values, each of the plurality of second weight values corresponding to a respective one of the plurality of second kernels. In some aspects, the first non-linear model may be based on a summation of the plurality of kernels that are respectively adjusted based on the plurality of first weight values.

At block 1108, the network entity may receive, from the UE, uplink communication including uplink data according to the indicated QCL type. For example, the communication management circuitry 1042 shown and described above in connection with FIG. 10 may provide means for receiving the uplink communication. In an aspect, the uplink communication may be a PUSCH communication.

At block 1110, the network entity may process the received uplink communication based on a second non-linear model that is based on the first non-linear model. For example, the communication management circuitry 1042 shown and described above in connection with FIG. 10 may provide means for processing the received uplink communication.

In some aspects, the second non-linear model may be identical to the first non-linear model according to the indicated QCL type. In some aspects, a port for the reference signal may be quasi co-located with a DMRS port for the uplink communication. In some aspects, a power control for receiving the reference signal may be based on a power control for receiving the uplink communication.

In some aspects, the second non-linear model may be based on the first non-linear model and may be different from the first non-linear model, according to the indicated QCL type.

In some aspects, the plurality of first kernels in the first non-linear model are the same as the plurality of second kernels in the second non-linear model, and the plurality of first weight values in the first non-linear model are different from the plurality of second weight values in the second non-linear model.

In some aspects, the first non-linear model includes a common portion and a first dedicated portion, and the second non-linear model includes the common portion and a second dedicated portion different from the first dedicated portion, the common portion being based on at least one of the plurality of first kernels and at least one of the plurality of first weight values.

In some aspects, a port for the reference signal may be quasi co-located with each of two DMRS ports for the uplink communication according to the indicated QCL type, and wherein the two DMRS ports are quasi co-located with each other according to the second non-linear model.

In some aspects, a port for the reference signal may be quasi co-located with each of two DMRS ports for the uplink communication according to the indicated QCL type, and wherein the two DMRS ports are quasi co-located with each other according to the second non-linear model when at least one of following conditions is satisfied: the two DMRS ports being utilized for two consecutive repetitions of the uplink communication, the two DMRS ports being utilized for two consecutive slots for a TBoMS transmission, or the two DMRS ports being utilized in a transmission of the uplink communication.

In some aspects, at block 1112, the network entity may transmit a MAC-CE including a second QCL indication indicating a second QCL type from the plurality of QCL types, the second QCL type being different from the default QCL type. For example, the communication management circuitry 1042 shown and described above in connection with FIG. 10 may provide means for transmitting the MAC-CE.

In some aspects, at block 1114, the network entity may receive, from the UE, second uplink communication according to the second QCL type. For example, the communication management circuitry 1042 shown and described above in connection with FIG. 10 may provide means for receiving the second uplink communication.

In some aspects, the transmitting at 1102, by the UE, the QCL indication indicating the QCL type may include transmitting a radio resource control (RRC) configuration message for the uplink communication, the RRC configuration message including the QCL indication. In this aspect, at block 1116, the network entity may transmit DCI including a configured grant for transmission of the uplink communication. For example, the communication management circuitry 1042 shown and described above in connection with FIG. 10 may provide means for transmitting the DCI.

In one configuration, the network entity 1000 for wireless communication includes means for transmitting, to a UE, a QCL indication indicating a QCL type, means for receiving, from the UE, a reference signal according to the indicated QCL type, means for determining a first non-linear model based on the received reference signal, means for receiving, from the UE, uplink communication including uplink data according to the indicated QCL type, and means for processing the received uplink communication based on a second non-linear model that is based on the first non-linear model. In some aspects, the network entity 1000 may further include means for transmitting a MAC-CE including a second QCL indication indicating a second QCL type from the plurality of QCL types, the second QCL type being different from the default QCL type, and means for receiving, from the UE, second uplink communication according to the second QCL type. In some aspects, the network entity 1000 may further include means for transmitting DCI including a configured grant for transmission of the uplink communication.

In one aspect, the aforementioned means may be the processor(s) 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 3, 8, and/or 9, and utilizing, for example, the processes and/or algorithms described herein in relation to FIG. 11.

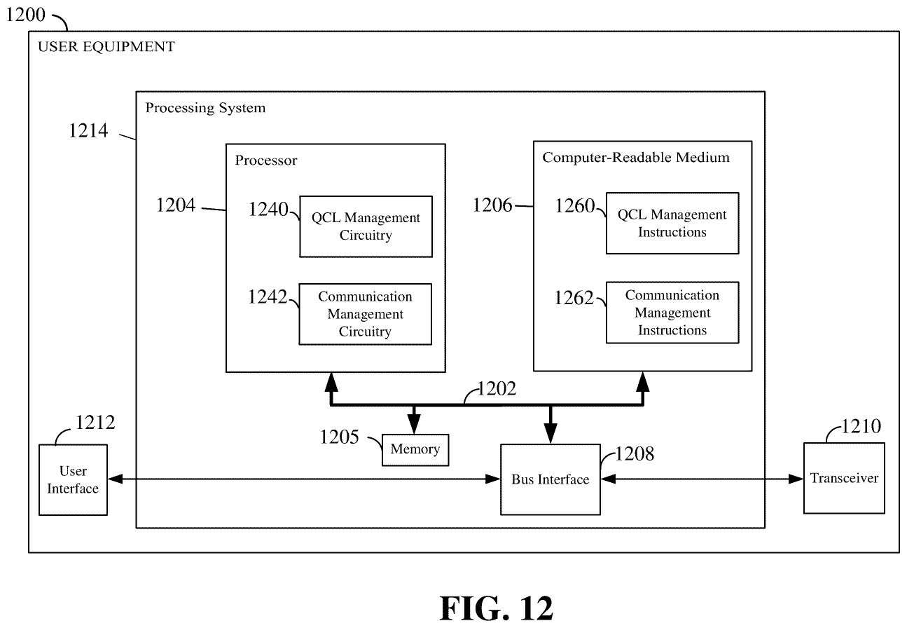

FIG. 12 is a conceptual diagram illustrating an example of a hardware implementation for an exemplary user equipment (UE) 1200 employing a processing system 1214. In accordance with various aspects of the disclosure, an element, or any portion of an element, or any combination of elements may be implemented with a processing system 1214 that includes one or more processors 1204. For example, the user equipment 1200 may be a user equipment (UE) as illustrated in any one or more of FIGS. 1, 2, 3, 8, and/or 9.

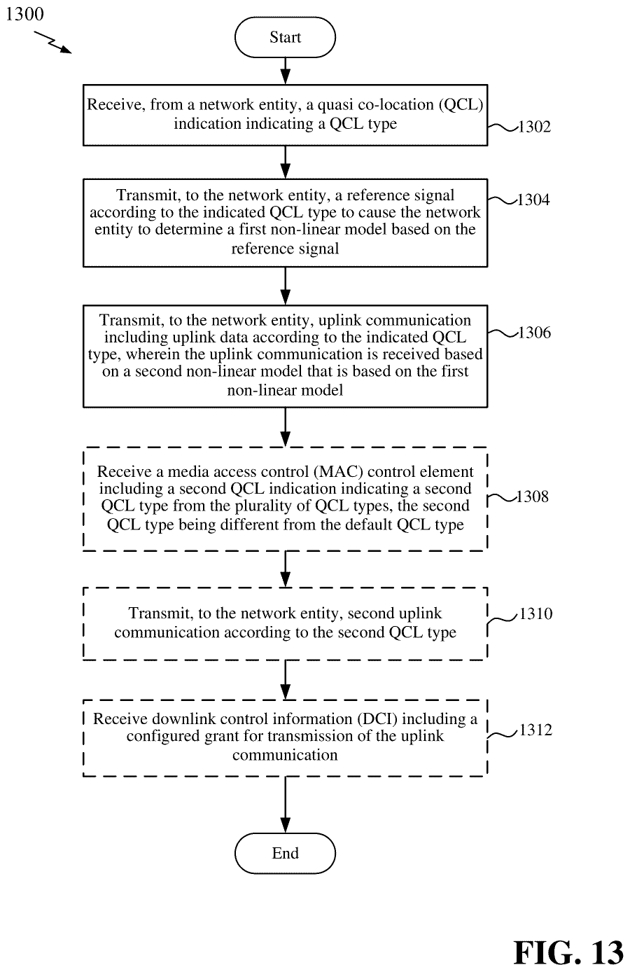

The processing system 1214 may be substantially the same as the processing system 1014 illustrated in FIG. 10, including a bus interface 1208, a bus 1202, memory 1205, a processor 1204, and a computer-readable storage medium 1206. Furthermore, the user equipment 1200 may include a user interface 1212 and a transceiver 1210 substantially similar to those described above in FIG. 10. That is, the processor 1204, as utilized in a user equipment 1200, may be used to implement any one or more of the processes described below and illustrated in FIG. 13.

In some aspects of the disclosure, the processor 1204 may include QCL management circuitry 1240 configured for various functions, including, for example, receiving, from a network entity, a QCL indication indicating a QCL type. For example, the QCL management circuitry 1240 may be configured to implement one or more of the functions described below in relation to FIG. 13, including, e.g., block 1302.

In some aspects of the disclosure, the processor 1204 may include communication management circuitry 1262 configured for various functions, including, for example, transmitting, to the network entity, a reference signal according to the indicated QCL type to cause the network entity to determine a first non-linear model based on the reference signal. For example, the communication management circuitry 1262 may be configured to implement one or more of the functions described below in relation to FIG. 13, including, e.g., block 1304.

In some aspects, the communication management circuitry 1262 may be configured for various functions, including, for example, transmitting, to the network entity, uplink communication including uplink data according to the indicated QCL type, wherein the uplink communication is received based on a second non-linear model that is based on the first non-linear model. For example, the communication management circuitry 1262 may be configured to implement one or more of the functions described below in relation to FIG. 13, including, e.g., block 1306.

In some aspects, the communication management circuitry 1262 may be configured for various functions, including, for example, receiving a MAC-CE including a second QCL indication indicating a second QCL type from the plurality of QCL types, the second QCL type being different from the default QCL type. For example, the communication management circuitry 1262 may be configured to implement one or more of the functions described below in relation to FIG. 13, including, e.g., block 1308.

In some aspects, the communication management circuitry 1262 may be configured for various functions, including, for example, transmitting, to the network entity, second uplink communication according to the second QCL type. For example, the communication management circuitry 1262 may be configured to implement one or more of the functions described below in relation to FIG. 13, including, e.g., block 1310.

In some aspects, the communication management circuitry 1262 may be configured for various functions, including, for example, receiving DCI including a configured grant for transmission of the uplink communication. For example, the communication management circuitry 1262 may be configured to implement one or more of the functions described below in relation to FIG. 13, including, e.g., block 1312.

In some aspects of the disclosure, the computer-readable storage medium 1206 may include QCL management software/instructions 1260 configured for various functions, including, for example, receiving, from a network entity, a QCL indication indicating a QCL type. For example, the QCL management software/instructions 1260 may be configured to implement one or more of the functions described below in relation to FIG. 13, including, e.g., block 1302.

In some aspects of the disclosure, the computer-readable storage medium 1206 may include communication management circuitry 1262 configured for various functions, including, for example, transmitting, to the network entity, a reference signal according to the indicated QCL type to cause the network entity to determine a first non-linear model based on the reference signal. For example, the communication management circuitry 1262 may be configured to implement one or more of the functions described below in relation to FIG. 13, including, e.g., block 1304.

In some aspects, the communication management circuitry 1262 may be configured for various functions, including, for example, transmitting, to the network entity, uplink communication including uplink data according to the indicated QCL type, wherein the uplink communication is received based on a second non-linear model that is based on the first non-linear model. For example, the communication management circuitry 1262 may be configured to implement one or more of the functions described below in relation to FIG. 13, including, e.g., block 1306.

In some aspects, the communication management circuitry 1262 may be configured for various functions, including, for example, receiving a MAC-CE including a second QCL indication indicating a second QCL type from the plurality of QCL types, the second QCL type being different from the default QCL type. For example, the communication management circuitry 1262 may be configured to implement one or more of the functions described below in relation to FIG. 13, including, e.g., block 1308.

In some aspects, the communication management circuitry 1262 may be configured for various functions, including, for example, transmitting, to the network entity, second uplink communication according to the second QCL type. For example, the communication management circuitry 1262 may be configured to implement one or more of the functions described below in relation to FIG. 13, including, e.g., block 1310.

In some aspects, the communication management circuitry 1262 may be configured for various functions, including, for example, receiving DCI including a configured grant for transmission of the uplink communication. For example, the communication management circuitry 1262 may be configured to implement one or more of the functions described below in relation to FIG. 13, including, e.g., block 1312.

FIG. 13 is a flow chart illustrating an exemplary process 1300 for a user equipment (UE) in accordance with some aspects. As described below, some or all illustrated features may be omitted in a particular implementation within the scope of the present disclosure, and some illustrated features may not be required for implementation of all embodiments. In some examples, the process 1300 may be carried out by the network entity 1000 illustrated in FIG. 10. In some examples, the process 1300 may be carried out by any suitable apparatus or means for carrying out the functions or algorithm described below.

At block 1302, the UE may receive, from a network entity, a QCL indication indicating a QCL type. For example, the QCL management circuitry 1240 shown and described above in connection with FIG. 10 may provide means for receiving the QCL indication.

At block 1304, the UE may transmit, to the network entity, a reference signal according to the indicated QCL type to cause the network entity to determine a first non-linear model based on the reference signal. For example, the communication management circuitry 1242 shown and described above in connection with FIG. 10 may provide means for transmitting the reference signal. In an aspect, the reference signal may be an SRS.

In some aspects, the first non-linear model may be based on a plurality of first kernels that are based on the received reference signal and a plurality of first weight values, each of the plurality of first weight values corresponding to a respective one of the plurality of first kernels, and the second non-linear model may be based on a plurality of second kernels that are based on the received reference signal and a plurality of second weight values, each of the plurality of second weight values corresponding to a respective one of the plurality of second kernels. In some aspects, the first non-linear model may be based on a summation of the plurality of kernels that are respectively adjusted based on the plurality of first weight values.

At block 1306, the UE may transmit, to the network entity, uplink communication including uplink data according to the indicated QCL type, wherein the uplink communication is received based on a second non-linear model that is based on the first non-linear model. For example, the communication management circuitry 1242 shown and described above in connection with FIG. 10 may provide means for transmitting the uplink communication. In an aspect, the uplink communication may be a PUSCH communication.

In some aspects, the second non-linear model may be identical to the first non-linear model according to the indicated QCL type. In some aspects, a port for the reference signal may be quasi co-located with a DMRS port for the uplink communication. In some aspects, a power control for receiving the reference signal may be based on a power control for receiving the uplink communication.

In some aspects, the second non-linear model may be based on the first non-linear model and may be different from the first non-linear model, according to the indicated QCL type.

In some aspects, the plurality of first kernels in the first non-linear model are the same as the plurality of second kernels in the second non-linear model, and the plurality of first weight values in the first non-linear model are different from the plurality of second weight values in the second non-linear model.

In some aspects, the first non-linear model includes a common portion and a first dedicated portion, and the second non-linear model includes the common portion and a second dedicated portion different from the first dedicated portion, the common portion being based on at least one of the plurality of first kernels and at least one of the plurality of first weight values.

In some aspects, a port for the reference signal may be quasi co-located with each of two DMRS ports for the uplink communication according to the indicated QCL type, and wherein the two DMRS ports are quasi co-located with each other according to the second non-linear model.

In some aspects, a port for the reference signal may be quasi co-located with each of two DMRS ports for the uplink communication according to the indicated QCL type, and wherein the two DMRS ports are quasi co-located with each other according to the second non-linear model when at least one of following conditions is satisfied: the two DMRS ports being utilized for two consecutive repetitions of the uplink communication, the two DMRS ports being utilized for two consecutive slots for a TBoMS transmission, or the two DMRS ports being utilized in a transmission of the uplink communication.

In some aspects, at block 1308, the UE may receive a MAC-CE including a second QCL indication indicating a second QCL type from the plurality of QCL types, the second QCL type being different from the default QCL type. For example, the communication management circuitry 1242 shown and described above in connection with FIG. 10 may provide means for receiving the MAC-CE.

In some aspects, at block 1310, the UE may transmit, to the network entity, second uplink communication according to the second QCL type. For example, the communication management circuitry 1242 shown and described above in connection with FIG. 10 may provide means for transmitting the second uplink communication.

In some aspects, at block 1312, the UE may receive DCI including a configured grant for transmission of the uplink communication. For example, the communication management circuitry 1242 shown and described above in connection with FIG. 10 may provide means for receiving the DCI.

In one configuration, the UE 1200 for wireless communication includes means for receiving, from a network entity, a QCL indication indicating a QCL type, means for transmitting, to the network entity, a reference signal according to the indicated QCL type to cause the network entity to determine a first non-linear model based on the reference signal, and means for transmitting, to the network entity, uplink communication including uplink data according to the indicated QCL type, wherein the uplink communication is received based on a second non-linear model that is based on the first non-linear model. In some aspects, the UE 1200 may further include means for receiving a MAC-CE including a second QCL indication indicating a second QCL type from the plurality of QCL types, the second QCL type being different from the default QCL type, and means for transmitting, to the network entity, second uplink communication according to the second QCL type. In some aspects, the UE 1200 may further include means for receiving downlink control information (DCI) including a configured grant for transmission of the uplink communication. In one aspect, the aforementioned means may be the processor(s) 1204 shown in FIG. 12 configured to perform the functions recited by the aforementioned means. In another aspect, the aforementioned means may be a circuit or any apparatus configured to perform the functions recited by the aforementioned means.

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1, 2, 3, 8, and/or 9, and utilizing, for example, the processes and/or algorithms described herein in relation to FIG. 13.

The following provides an overview of several aspects of the present disclosure.

Aspect 1: A method of wireless communication by a network entity, comprising: transmitting, to a user equipment (UE), a quasi co-location (QCL) indication indicating a QCL type; receiving, from the UE, a reference signal according to the indicated QCL type; determining a first non-linear model based on the received reference signal; receiving, from the UE, uplink communication including uplink data according to the indicated QCL type; and processing the received uplink communication based on a second non-linear model that is based on the first non-linear model.

Aspect 2: The method of aspect 1, wherein the first non-linear model is based on a plurality of first kernels that are based on the received reference signal and a plurality of first weight values, each of the plurality of first weight values corresponding to a respective one of the plurality of first kernels, and wherein the second non-linear model is based on a plurality of second kernels that are based on the received reference signal and a plurality of second weight values, each of the plurality of second weight values corresponding to a respective one of the plurality of second kernels.

Aspect 3: The method of aspect 2, wherein the first non-linear model is based on a summation of the plurality of kernels that are respectively adjusted based on the plurality of first weight values.

Aspect 4: The method of aspect 2 or 3, wherein the second non-linear model is identical to the first non-linear model according to the indicated QCL type.

Aspect 5: The method of aspect 4, wherein a port for the reference signal is quasi co-located with a demodulation reference signal (DMRS) port for the uplink communication.

Aspect 6: The method of aspect 5, wherein a power control for receiving the reference signal is based on a power control for receiving the uplink communication.

Aspect 7: The method of aspect 2 or 3, wherein the second non-linear model is based on the first non-linear model and is different from the first non-linear model, according to the indicated QCL type:

Aspect 8: The method of aspect 7, wherein the plurality of first kernels in the first non-linear model are the same as the plurality of second kernels in the second non-linear model, and the plurality of first weight values in the first non-linear model are different from the plurality of second weight values in the second non-linear model.

Aspect 9: The method of aspect 7, wherein the first non-linear model includes a common portion and a first dedicated portion, and the second non-linear model includes the common portion and a second dedicated portion different from the first dedicated portion, the common portion being based on at least one of the plurality of first kernels and at least one of the plurality of first weight values.

Aspect 10: The method of any of aspects 7 through 9, wherein a port for the reference signal is quasi co-located with each of two demodulation reference signal (DMRS) ports for the uplink communication according to the indicated QCL type, and wherein the two DMRS ports are quasi co-located with each other according to the second non-linear model.

Aspect 11: The method of any of aspects 7 through 9, wherein a port for the reference signal is quasi co-located with each of two demodulation reference signal (DMRS) ports for the uplink communication according to the indicated QCL type, and wherein the two DMRS ports are quasi co-located with each other according to the second non-linear model when at least one of following conditions is satisfied: the two DMRS ports being utilized for two consecutive repetitions of the uplink communication, the two DMRS ports being utilized for two consecutive slots for a transport block over multiple slots (TBoMS) transmission, or the two DMRS ports being utilized in a transmission of the uplink communication.

Aspect 12: The method of any of aspects 1 through 11, wherein the transmitting the QCL indication indicating the QCL type comprises: transmitting at least one of a first radio resource control (RRC) configuration message for the reference signal or a second RRC configuration message for the uplink communication, the at least one of the first RRC configuration message or the second RRC configuration message including the QCL indication.

Aspect 13: The method of any of aspects 1 through 11, wherein the transmitting the QCL indication indicating the QCL type comprises at least one of: transmitting downlink control information (DCI) including the QCL indication, or transmitting a media access control (MAC) control element including the QCL indication.

Aspect 14: The method of any of aspects 1 through 11, wherein the transmitting the QCL indication indicating the QCL type comprises: transmitting a radio resource control (RRC) configuration message for the uplink communication, the RRC configuration message including a configured grant for transmission of the uplink communication and a listing a plurality of QCL types, the RRC configuration message indicating a default QCL type from the plurality of QCL types, the QCL indication being one of the plurality of QCL types.

Aspect 15: The method of aspect 14, further comprising: transmitting a media access control (MAC) control element including a second QCL indication indicating a second QCL type from the plurality of QCL types, the second QCL type being different from the default QCL type; and receiving, from the UE, second uplink communication according to the second QCL type.

Aspect 16: The method of any of aspects 1 through 11, wherein the transmitting the QCL indication indicating the QCL type comprises transmitting a radio resource control (RRC) configuration message for the uplink communication, the RRC configuration message including the QCL indication, and wherein the method further comprises transmitting downlink control information (DCI) including a configured grant for transmission of the uplink communication.

Aspect 17: The method of any of aspects 1 through 16, wherein the reference signal is a sounding reference signal (SRS), and the uplink communication is physical uplink shared channel (PUSCH) communication.

Aspect 18: A network entity comprising: a transceiver configured to communicate with a radio access network, a memory, and a processor communicatively coupled to the transceiver and the memory, wherein the processor and the memory are configured to perform any one of aspects 1 through 17.

Aspect 19: A network entity configured for wireless communication comprising at least one means for performing any one of aspects 1 through 17.

Aspect 20: A non-transitory computer-readable storage medium having instructions for a network entity thereon, wherein the instructions, when executed by a processing circuit, cause the processing circuit to perform any one of aspects 1 through 17.

Aspect 21. A method of wireless communication by a user equipment (UE), comprising: receiving, from a network entity, a quasi co-location (QCL) indication indicating a QCL type; transmitting, to the network entity, a reference signal according to the indicated QCL type to cause the network entity to determine a first non-linear model based on the reference signal; and transmitting, to the network entity, uplink communication including uplink data according to the indicated QCL type, wherein the uplink communication is received based on a second non-linear model that is based on the first non-linear model.

Aspect 22. The method of aspect 21, wherein the first non-linear model is based on a plurality of first kernels that are based on the received reference signal and a plurality of first weight values, each of the plurality of first weight values corresponding to a respective one of the plurality of first kernels, and wherein the second non-linear model is based on a plurality of second kernels that are based on the received reference signal and a plurality of second weight values, each of the plurality of second weight values corresponding to a respective one of the plurality of second kernels.

Aspect 23. The method of aspect 22, wherein the first non-linear model is based on a summation of the plurality of kernels that are respectively adjusted based on the plurality of first weight values.

Aspect 24. The method of aspect 22 or 23, wherein the second non-linear model is identical to the first non-linear model according to the indicated QCL type.

Aspect 25. The method of aspect 24, wherein a port for the reference signal is quasi co-located with a demodulation reference signal (DMRS) port for the uplink communication.

Aspect 26. The method of aspect 25, wherein a power control for receiving the reference signal is based on a power control for receiving the uplink communication.

Aspect 27. The method of aspect 22 or 23, wherein the second non-linear model is based on the first non-linear model and is different from the first non-linear model, according to the indicated QCL type.

Aspect 28. The method of aspect 27, wherein the plurality of first kernels in the first non-linear model are the same as the plurality of second kernels in the second non-linear model, and the plurality of first weight values in the first non-linear model are different from the plurality of second weight values in the second non-linear model.

Aspect 29. The method of aspect 27, wherein the first non-linear model includes a common portion and a first dedicated portion, and the second non-linear model includes the common portion and a second dedicated portion different from the first dedicated portion, the common portion being based on at least one of the plurality of first kernels and at least one of the plurality of first weight values.

Aspect 30. The method of any of aspects 27 through 29, wherein a port for the reference signal is quasi co-located with each of two demodulation reference signal (DMRS) ports for the uplink communication according to the indicated QCL type, and wherein the two DMRS ports are quasi co-located with each other according to the second non-linear model.

Aspect 31. The method of any of aspects 27 through 29, wherein a port for the reference signal is quasi co-located with each of two demodulation reference signal (DMRS) ports for the uplink communication according to the indicated QCL type, and wherein the two DMRS ports are quasi co-located with each other according to the second non-linear model when at least one of following conditions is satisfied: the two DMRS ports being utilized for two consecutive repetitions of the uplink communication, the two DMRS ports being utilized for two consecutive slots for a transport block over multiple slots (TBoMS) transmission, or the two DMRS ports being utilized in a transmission of the uplink communication.

Aspect 32. The method of any of aspects 21 through 31, wherein the receiving the QCL indication indicating the QCL type comprises: receiving at least one of a first radio resource control (RRC) configuration message for the reference signal or a second RRC configuration message for the uplink communication, the at least one of the first RRC configuration message or the second RRC configuration message including the QCL indication.

Aspect 33. The method of any of aspects 21 through 31, wherein the receiving the QCL indication indicating the QCL type comprises at least one of: receiving downlink control information (DCI) including the QCL indication, or receiving a media access control (MAC) control element including the QCL indication.

Aspect 34. The method of any of aspects 21 through 31, wherein the receiving the QCL indication indicating the QCL type comprises: receiving a radio resource control (RRC) configuration message for the uplink communication, the RRC configuration message including a configured grant for transmission of the uplink communication and a listing a plurality of QCL types, the RRC configuration message indicating a default QCL type from the plurality of QCL types, the QCL indication being one of the plurality of QCL types.

Aspect 35. The method of aspect 34, further comprising: receiving a media access control (MAC) control element including a second QCL indication indicating a second QCL type from the plurality of QCL types, the second QCL type being different from the default QCL type; and transmitting, to the network entity, second uplink communication according to the second QCL type.

Aspect 36. The method of any of aspects 21 through 31, wherein the receiving the QCL indication indicating the QCL type comprises receiving a radio resource control (RRC) configuration message for the uplink communication, the RRC configuration message including the QCL indication, and wherein the method further comprises receiving downlink control information (DCI) including a configured grant for transmission of the uplink communication.

Aspect 37. The method of any of aspects 21 through 36, wherein the reference signal is a sounding reference signal (SRS), and the uplink communication is physical uplink shared channel (PUSCH) communication.

Aspect 38: A user equipment (UE) comprising: a transceiver configured to communicate with a radio access network, a memory, and a processor communicatively coupled to the transceiver and the memory, wherein the processor and the memory are configured to perform any one of aspects 21 through 37.

Aspect 39: A UE configured for wireless communication comprising at least one means for performing any one of aspects 21 through 37.

Aspect 40: A non-transitory computer-readable storage medium having instructions for a UE thereon, wherein the instructions, when executed by a processing circuit, cause the processing circuit to perform any one of aspects 21 through 37.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-13 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-13 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

1. A method of wireless communication by a network entity, comprising:
transmitting, to a user equipment (UE), a quasi co-location (QCL) indication indicating a QCL type;
receiving, from the UE, a reference signal according to the indicated QCL type;
determining a first non-linear model based on the received reference signal;
receiving, from the UE, uplink communication including uplink data according to the indicated QCL type; and
processing the received uplink communication based on a second non-linear model that is based on the first non-linear model.

2. The method of claim 1, wherein the first non-linear model is based on a plurality of first kernels that are based on the received reference signal and a plurality of first weight values, each of the plurality of first weight values corresponding to a respective one of the plurality of first kernels, and
wherein the second non-linear model is based on a plurality of second kernels that are based on the received reference signal and a plurality of second weight values, each of the plurality of second weight values corresponding to a respective one of the plurality of second kernels.

3. (canceled)

4. The method of claim 32, wherein a port for the reference signal is quasi co-located with a demodulation reference signal (DMRS) port for the uplink communication.

5. The method of claim 4, wherein a power control for receiving the reference signal is based on a power control for receiving the uplink communication.

6. (canceled)

7. The method of claim 62, wherein the plurality of first kernels in the first nonlinear model are the same as the plurality of second kernels in the second non-linear model, and the plurality of first weight values in the first non-linear model are different from the plurality of second weight values in the second non-linear model.

8. The method of claim 62, wherein the first non-linear model includes a common portion and a first dedicated portion, and the second non-linear model includes the common portion and a second dedicated portion different from the first dedicated portion, the common portion being based on at least one of the plurality of first kernels and at least one of the plurality of first weight values.

9. The method of claim 62, wherein a port for the reference signal is quasi co-located with each of two demodulation reference signal (DMRS) ports for the uplink communication according to the indicated QCL type, and wherein the two DMRS ports are quasi co-located with each other according to the second non-linear model.

10. The method of claim 62, wherein a port for the reference signal is quasi co-located with each of two demodulation reference signal (DMRS) ports for the uplink communication according to the indicated QCL type, and wherein the two DMRS ports are quasi co-located with each other according to the second non-linear model when at least one of following conditions is satisfied:
the two DMRS ports being utilized for two consecutive repetitions of the uplink communication,
the two DMRS ports being utilized for two consecutive slots for a transport block over multiple slots (TBoMS) transmission, or
the two DMRS ports being utilized in a transmission of the uplink communication.

11. The method of claim 1, wherein the transmitting the QCL indication indicating the QCL type comprises:
transmitting at least one of a first radio resource control (RRC) configuration message for the reference signal or a second RRC configuration message for the uplink communication, the at least one of the first RRC configuration message or the second RRC configuration message including the QCL indication.

12. The method of claim 1, wherein the transmitting the QCL indication indicating the QCL type comprises at least one of:
transmitting downlink control information (DCI) including the QCL indication, or
transmitting a media access control (MAC) control element including the QCL indication.

13. The method of claim 1, wherein the transmitting the QCL indication indicating the QCL type comprises:
transmitting a radio resource control (RRC) configuration message for the uplink communication, the RRC configuration message including a configured grant for transmission of the uplink communication and a listing a plurality of QCL types, the RRC configuration message indicating a default QCL type from the plurality of QCL types, the QCL indication being one of the plurality of QCL types.

14. The method of claim 13, further comprising:
transmitting a media access control (MAC) control element including a second QCL indication indicating a second QCL type from the plurality of QCL types, the second QCL type being different from the default QCL type; and
receiving, from the UE, second uplink communication according to the second QCL type.

15. The method of claim 1, wherein the transmitting the QCL indication indicating the QCL type comprises transmitting a radio resource control (RRC) configuration message for the uplink communication, the RRC configuration message including the QCL indication, and wherein the method further comprises transmitting downlink control information (DCI) including a configured grant for transmission of the uplink communication.

16. (canceled)

17. A method of wireless communication by a user equipment (UE), comprising:
receiving, from a network entity, a quasi co-location (QCL) indication indicating a QCL type;
transmitting, to the network entity, a reference signal according to the indicated QCL type to cause the network entity to determine a first non-linear model based on the reference signal; and
transmitting, to the network entity, uplink communication including uplink data according to the indicated QCL type, wherein the uplink communication is received based on a second non-linear model that is based on the first non-linear model.

18-19. (canceled)

20. The method of claim 17, wherein a power control for receiving the reference signal is based on a power control for receiving the uplink communication.

21-22. (canceled)

23. The method of claim 17, wherein a port for the reference signal is quasi co-located with each of two demodulation reference signal (DMRS) ports for the uplink communication according to the indicated QCL type, and wherein the two DMRS ports are quasi co-located with each other according to the second non-linear model.

24. The method of claim 17, wherein a port for the reference signal is quasi co-located with each of two demodulation reference signal (DMRS) ports for the uplink communication according to the indicated QCL type, and wherein the two DMRS ports are quasi co-located with each other according to the second non-linear model when at least one of following conditions is satisfied:
the two DMRS ports being utilized for two consecutive repetitions of the uplink communication,
the two DMRS ports being utilized for two consecutive slots for a transport block over multiple slots (TBoMS) transmission, or
the two DMRS ports being utilized in a transmission of the uplink communication.

25-26. (canceled)

27. The method of claim 17, wherein the receiving the QCL indication indicating the QCL type comprises:
receiving a radio resource control (RRC) configuration message for the uplink communication, the RRC configuration message including a configured grant for transmission of the uplink communication and a listing a plurality of QCL types, the RRC configuration message indicating a default QCL type from the plurality of QCL types, the QCL indication being one of the plurality of QCL types.

28. The method of claim 27, further comprising:
receiving a media access control (MAC) control element including a second QCL indication indicating a second QCL type from the plurality of QCL types, the second QCL type being different from the default QCL type; and
transmitting, to the network entity, second uplink communication according to the second QCL type.

29. The method of claim 17, wherein the receiving the QCL indication indicating the QCL type comprises receiving a radio resource control (RRC) configuration message for the uplink communication, the RRC configuration message including the QCL indication, and
wherein the method further comprises receiving downlink control information (DCI) including a configured grant for transmission of the uplink communication.

30. (canceled)
